(19) United States
(12) Patent Application Publication
(10) Pub. No.: US 2012/0027658 A1
(43) Pub. Date: Feb. 2, 2012

(54) Oxidation Catalysts Useful for Ambient Temperature Operation

(76) Inventors: Christopher J. Karwacki, Churchville, MD (US); Yury Gogotsi, Ivyland, PA (US); Gregory W. Peterson, Beleamp, MD (US)

(21) Appl. No.: 13/051,051

(22) Filed: Mar. 18, 2011

Related U.S. Application Data
(60) Provisional application No. 61/369,418, filed on Jul. 30, 2010.

(51) Int. Cl. B01J 23/52; B01J 23/10; B01J 23/46; B01J 23/72; B01J 23/06; B01J 21/06; B01D 53/62; B01J 35/10; B01J 23/42; B82Y 30/00

(52) U.S. Cl. 423/247; 502/300; 502/344; 502/304; 502/325; 502/339; 502/345; 502/343; 502/349; 977/902

(57) ABSTRACT

A catalytic sorbent material includes a porous support composed of a hydroxylated metal oxide, preferably hydroxylated zirconia, and catalytic metal nanoparticles, preferably gold nanoparticles, loaded on the porous support. These catalysts can be utilized to convert carbon monoxide into carbon dioxide at relatively low temperatures.

### CROSS-REFERENCE TO RELATED APPLICATION

This application claims the benefit of U.S. Provisional Patent Application No. 61/369,418, filed Jul. 30, 2010.

### GOVERNMENT INTEREST

The invention described herein may be manufactured, used and licensed by or for the U.S. Government.

### FIELD OF THE INVENTION

The present invention relates to catalytic materials, and more particularly to zirconium-based catalytic sorbents formulated for decontaminating carbon monoxide from air streams at temperatures under 150° C.

### BACKGROUND OF THE INVENTION

Carbon monoxide, a by-product of partial oxidation of carbon containing compounds, is a colorless, odorless and tasteless gas that is highly toxic to humans and animals at sufficient concentrations. Carbon monoxide poisoning resulting in asphyxiation results in more deaths and illnesses than any other chemical in both the military population and the general population at large. Carbon monoxide is known to be difficult to isolate and remove from ambient air at room temperature. For these reasons, greater attention has been focused on removing carbon monoxide from ambient air and converting it into carbon dioxide.

Catalyst formulations and materials utilizing catalytically active metals such as platinum, rhodium, copper and the like, have been studied for oxidizing carbon monoxide. However, such catalyst materials typically require high operating temperatures of at least 300° C. to initiate appreciable activity. For example, catalytic oxidation systems used in combustion-based processes to mitigate release of carbon monoxide via conversion to carbon dioxide are known to be highly inefficient during initial start-up (cold-start) when the exhaust temperatures are well below 300° C. Such catalysts would not be useful in applications such as respiratory filtration where such high operating temperatures or the energy needed to sustain such temperatures are not desirable or unavailable.

Catalysts belonging to a class called hopcalite have been found to catalytically remove carbon monoxide from air. Hopcalite-based catalysts usually contain large clusters of metal oxide; however they are highly sensitive to moisture levels. Excessive moisture can undesirably deactivate the catalyst. Generally, a filter containing very high mass fractions of water adsorbents must be placed upstream from hopcalite-based catalysts to ensure low moisture levels in the air stream to be processed.

Catalytic sorbents containing nanoparticles (i.e., particle size of less than 10 nm) of a catalytic metal dispersed on an active support containing a metal oxide provide a promising option. One catalytic sorbent includes nanoparticles of gold dispersed on an active support of titanium oxide or titania (referred hereinafter as “Au—TiO₂”). Au—TiO₂ has been observed to catalytically oxidize carbon monoxide to generate carbon dioxide at relatively low levels of thermal energy input, while effectively sustaining adsorption, reaction and regeneration at normal ambient temperatures. However, Au—TiO₂ exhibits a limited performance profile due to the low surface concentration of hydroxyl ion sites and the relatively low surface area, typically about 50 m²g⁻¹. In addition, Au—TiO₂ requires precise control of water within a narrow range to optimize reaction conditions. Unfortunately, even mere variability in relative humidity under normal atmospheric conditions can adversely affect the performance of Au—TiO₂.

Accordingly, there is a need to provide improved catalytic sorbents for relatively low temperature decontamination of carbon monoxide in air streams. There is a further need to provide improved catalytic sorbents having elevated levels of porosity and surface area, and ability to form hydroxyl groups from adsorbed water resulting in a greater concentration of active surface functional groups such as hydroxyl groups.

### SUMMARY OF THE INVENTION

The present invention relates generally to a catalytic sorbent useful for low temperature decontamination of carbon monoxide. Broadly, the catalytic sorbent of the present invention includes a porous support composed of hydroxylated metal oxide loaded with nanoparticles of a catalytic metal. The catalytic sorbent of the present invention contains enhanced concentrations of highly dispersed active surface function groups (e.g., hydroxyl groups). The catalytic sorbent of the present invention reacts catalytically upon contact with carbon monoxide to yield carbon dioxide at ambient temperatures. The catalytic sorbent of the present invention exhibits enhanced catalytic activity including, high reaction rates and high percent conversion yields of carbon dioxide (CO₂). The catalytic sorbent of the present invention can be readily adapted for various applications requiring decontamination of air streams containing carbon monoxide, and especially for use in respiratory filtration applications.

The invention involves synthetically-derived nanostructures comprising metal oxides which can be modified as a means to influence its properties to provide optimal catalytic performance over a range of operating conditions. The catalytic sorbents of the present invention can be designed to operate at normal ambient temperatures and temperatures of up to 150° C., and under both dry air conditions and conditions of high relative humidity.

In order to solve these and other problems in the art, the present invention provides specifically a catalytic sorbent having a porous support composed of hydroxylated metal oxide of amorphous composition, and a catalytic metal in the form of nanoparticles loaded on the porous support. The catalytic sorbent of the present invention exhibits catalytic reactivity against carbon monoxide, which is effectively neutralized in a rapid and efficient manner. The catalytic sorbent of the present invention is physically and chemically stable for use in catalytically reacting and neutralizing carbon monoxide preferably at temperatures between 25° C. to 150° C.

In the present invention, the hydroxylated metal oxide of the porous support is selected from a compound containing at least one metal element capable of dissociating adsorbed molecular water and generating hydroxyl groups, which chemically bond to the support surface thereof. The hydroxylated metal oxide preferably possesses an amorphous structure, consisting of less than 10 nm crystals, which provides for formation of elevated concentrations of surface bound hydroxyl groups.

In a preferred embodiment of the present invention, a catalytic sorbent is prepared with a porous support composed of hydroxylated zirconia, and gold nanoparticles loaded on the porous support and utilized to remove carbon monoxide from an air stream.

In one aspect of the present invention, there is provided a catalytic sorbent, which includes:

a porous support composed of hydroxylated metal oxide; and

a catalytic metal in the form of nanoparticles loaded on the porous support.

In a further aspect of the present invention, there is provided a catalytic sorbent which includes:

a porous support composed of hydroxylated zirconia; and

gold nanoparticles loaded on the porous support.

In another aspect of the present invention, there is provided a method of decontaminating an air stream suspected of containing carbon monoxide. The method includes:

a) preparing a catalytic sorbent comprising:
a porous support composed of hydroxylated metal oxide; and
a catalytic metal in the form of nanoparticles loaded on the porous support; and

b) passing the air stream through the catalytic sorbent.

### BRIEF DESCRIPTION OF THE DRAWINGS

The following drawings are illustrative of embodiments of the invention and are not intended to limit the invention as encompassed by the claims forming part of the invention.

FIGS. 1A, 1B, 1C, and 1D show transmission electron microscopy (TEM) images of gold and zirconia samples calcined at about 85° C., respectively, in accordance with one embodiment of the present invention;

FIGS. 2A, 2B, 2C, and 2D show transmission electron microscopy (TEM) images of gold and zirconia samples calcined at about 200° C. and 500° C., respectively, in accordance with another embodiment of the present invention;

FIG. 3 is a schematic diagram of a test apparatus implemented for investigating catalytic activity of various zirconia and titania samples in accordance with the present invention;

FIG. 4 a semi-logarithmic plot of catalytic activity showing a data comparison of carbon dioxide as a percent yield of samples containing gold nanoparticles dispersed on hydroxylated zirconia and titania, respectively, in accordance with the present invention;

FIG. 5 is a plot of catalytic activity showing data comparison of carbon dioxide as a percent yield of samples containing gold nanoparticles dispersed on hydroxylated zirconia at various pH values in accordance with the present invention;

FIG. 6 is a plot of catalytic activity showing data comparison of carbon dioxide as a percent yield of samples containing gold nanoparticles dispersed on hydroxylated zirconia under different conditions of humidity (dry and 25% RH) in accordance with the present invention; and

FIG. 7 is a plot of catalytic activity showing data comparison of carbon dioxide as a percent yield of samples containing gold nanoparticles dispersed on hydroxylated zirconia at varying temperatures in accordance with the present invention.

### DETAILED DESCRIPTION OF THE INVENTION

The present invention is directed to a catalytic sorbent useful for low temperature decontamination of carbon monoxide from air streams. Broadly, the catalytic sorbent of the present invention includes a porous support composed of hydroxylated metal oxide loaded with nanoparticles of a catalytic metal. The catalytic sorbent of the present invention contains enhanced concentrations of highly dispersed active surface function groups (e.g., hydroxyl groups). The catalytic sorbent of the present invention reacts catalytically upon contact with carbon monoxide to yield carbon dioxide at ambient temperatures. The catalytic sorbent of the present invention exhibits enhanced catalytic activity including, high reaction rates and high percent conversion yields of carbon dioxide (CO₂). The catalytic sorbent of the present invention can be readily adapted for various applications including decontamination of air streams containing toxic industrial chemicals, and especially for use in respiratory filtration applications.

In order to solve these and other problems in the art, the present invention provides specifically a catalytic sorbent having a porous support composed of hydroxylated metal oxide of amorphous composition, and a catalytic metal in the form of nanoparticles loaded on the porous support. The catalytic sorbent of the present invention exhibits catalytic reactivity against carbon monoxide, which is effectively neutralized in a rapid and efficient manner. The catalytic sorbent of the present invention is physically and chemically stable for use in catalytically reacting and neutralizing carbon monoxide preferably at temperatures of between 25° C. to 150° C.

In one embodiment of the present invention, there is provided a catalytic sorbent including a porous support composed of hydroxylated metal oxide of amorphous composition, and a catalytic metal in the form of nanoparticles loaded on the porous support. Depending on the type of process in which the present catalytic sorbent is used, the porous support can exist in any form including, for example, pellets, monoliths, powders, beds, and the like, which are suitable for promoting maximum contact with an air stream flowing or passing therethrough. Preferably, the porous support of the present invention exhibits high micro- and/or meso-pore volume to achieve increased overall surface area.

Preferably, the hydroxylated metal oxide of the porous support is selected from a compound containing at least one metal element capable of dissociating adsorbed molecular water and generating hydroxyl groups, which chemically bond to the support surface thereof. The hydroxylated metal oxide preferably possesses an amorphous structure, consisting of less than 10 nm crystals, which provides for formation of elevated concentrations of surface bound hydroxyl groups.

In a preferred embodiment of the present invention, a catalytic sorbent is prepared with a porous support composed of hydroxylated zirconia, and gold nanoparticles loaded on the porous support and utilized to remove carbon monoxide from an air stream.

The catalytic sorbents comprising nanoparticles of a catalytic metal such as gold loaded on a porous support composed of a hydroxylated metal oxide such as hydroxylated zirconia (e.g., zirconium (IV) hydroxide, Zr(OH)₄—H₂O) can be adapted to purify air streams containing carbon monoxide in almost any concentration.

The “catalytic metal” is intended to encompass any metal in a catalytically active state capable of neutralizing, decontaminating or catalytically converting a toxic industrial chemical such as carbon monoxide into one or more safer products. Examples of catalytic metals include gold, cerium, rhodium, platinum, copper, zinc, and the like. In a preferred embodiment of the present invention, the catalytic metal is gold.

The catalytic metal is present in a catalytically active amount sufficient to catalytically react with a toxic industrial chemical such as carbon monoxide to yield a less toxic product such as carbon dioxide at relatively low temperatures. In a preferred embodiment of the present invention, the catalytically active amount of the catalytic metal is at least 0.01% by weight based on the total weight of the catalytic sorbent, and preferably in the range of from about 0.1% by weight to 20% by weight based on the total weight of the catalytic sorbent, and more preferably from about 0.1% by weight to 5% by weight based on the total weight of the catalytic sorbent. Most preferably, the amount of the catalytic metal is about 1.0% by weight based on the total weight of the catalytic sorbent.

The term “nanoparticles” is intended to mean particles having a mean average particle size of less than 10 nm, and preferably in the range of from about 0.1 nm to 5 nm.

The catalytic metal nanoparticles of the present invention are incorporated or loaded onto a porous support composed of a hydroxylated metal oxide. The porous support may be meso-porous (i.e., pore sizes of less than 50 nm) or microporous (i.e., pore sizes of less than 2 nm). The crystal size of the porous support is less than 100 nm, preferably less than 10 nm, and more preferably less than 2 nm. The porous support has a surface area above about 100 m²g⁻¹, preferably from about 100 m²g⁻¹ to 1000 m²g⁻¹, and most preferably from about 300 m²g⁻¹ to 600 m²g⁻¹. The pore volume of the porous support is generally in the range of from about 0.01 cm³g⁻¹ to 0.8 cm³g⁻¹ and more preferably from about 0.2 cm³g⁻¹ to 0.8 cm³g⁻¹.

In a preferred embodiment of the present invention, the porous support has a pH value of from about 3 to 9, and more preferably about 6.

In the present invention, the hydroxylated metal oxide of the porous support is selected from a compound containing at least one metal element in a hydroxylated state capable of forming and supporting hydroxyl groups dispersed on the surface thereof. The hydroxylated metal oxide is preferably amorphous in structure.

The metal element of the hydroxylated metal oxide is selected from transition metals such as, for example, titanium, post-transition metals such as, for example, aluminum, silicon, zirconium, cerium, and hafnium, and combinations thereof. Preferably, the metal element is zirconium.

Examples of suitable hydroxylated metal oxides include zirconium (IV) hydroxide (Zr(OH)₄), zirconium (IV) hydroxide (Zr(OH)₄) zirconia (ZrO₂ nH₂O), hydroxylated polymorphic zirconia, zirconium oxyhydroxides, and combinations thereof. Preferably, the hydroxylated metal oxide is zirconium (IV) hydroxide (Zr(OH)₄). These descriptions of zirconia are variations of the same material with slightly different compositions emphasizing adsorbed water or disassociated water as hydroxyls. Hydroxylated zirconia provides enhanced porosity and surface area useful for forming and supporting higher concentration of hydroxyl surface groups.

The hydroxylated metal oxide of the present invention has a hydroxyl concentration in the range of from about 0.1 to 0.6 surface fraction based on the total available surface of the catalytic sorbent, and more preferably from about 0.3 to 0.5 surface fraction based on the total available surface of the catalytic sorbent.

In a preferred embodiment of the present invention, the amount of the hydroxylated metal oxide present in the catalytic sorbent can range from about from about 90% by weight to 99.9% by weight based on the total weight of the catalytic sorbent, and more preferably from about 95% by weight to 98% by weight based on the total weight of the catalytic sorbent.

In a preferred embodiment of the present invention, a catalytic sorbent is prepared with a porous support composed of hydroxylated zirconia, and gold nanoparticles loaded on the porous support and utilized to remove carbon monoxide from an air stream.

For purposes of the present invention, it will be understood by those of ordinary skill in the art that the terms “sufficient” and “effective” as used in conjunction with the terms “amount” and “conditions” represents a quantitative value that provides a satisfactory and desired result, e.g., detoxifying or neutralizing toxic industrial chemicals such as carbon monoxide which may be present in an air stream. The amounts, conditions and volume required to achieve the desired result will, of course, vary somewhat based upon the amount of toxic industrial chemical present, the flow rate, and volume of the air stream.

Broadly, and simply by way of example, the present catalytic sorbent is prepared by obtaining a hydroxylated form of a metal oxide such as hydroxylated zirconia, which is commercially prepared and available from various chemical supply vendors. The hydrous form of the metal oxide is calcined at an elevated temperature for a period of time. The calcined hydrous form of the metal oxide is then loaded with nanoparticles of a corresponding catalytic metal such as gold through any suitable means including, but not limited to, colloidal deposition, to yield the present catalyst sorbent. During the loading process, the resulting catalyst sorbent can be treated to adjust the pH between 3 and 9 using solutions of sodium hydroxide (NaOH) and hydrochloric acid (HOD.

In a particular example, a hydroxylated form of zirconia (designated herein as ZrO₂) was commercially prepared by Magnesium Elektron Inc. of Flemington, N.J. The hydroxylated form of zirconia was calcined at an elevated temperature in the range of from about 85° C. to 500° C., preferably from about 85° C. to 200° C., for about six hours, and then loaded with gold nanoparticles via the process of colloidal deposition. This involved the preparation of reduced gold nanoparticles from a solution of AuCl₃.HCl (7.5 ml, 0.008 M). The solution was diluted to 150 mL with 18 Mohm deionized water. To produce a sample with a particular pH between 3 and 9, the pH of the resulting solution was adjusted using 0.1 M NaOH and HCl. 1 mL of PVA (1 wt % in water) was added to the solution. The resulting solution was stirred at room temperature for about 2 hours. 120 μl NaBH₄ (0.5 M in 2-methoxyethyl ether) were added drop-wise resulting in a clear red solution.

The clear red solution containing reduced gold nanoparticles was added drop-wise to 100 ml deionized water containing 0.5 g ZrO₂-85 and followed by rapid stirring for about 12 hours at room temperature. The resulting sample solution was filtered, washed with distilled deionized water and dried at 85° C. The resulting catalytic sorbent sample contained about 2.0 wt % Au.

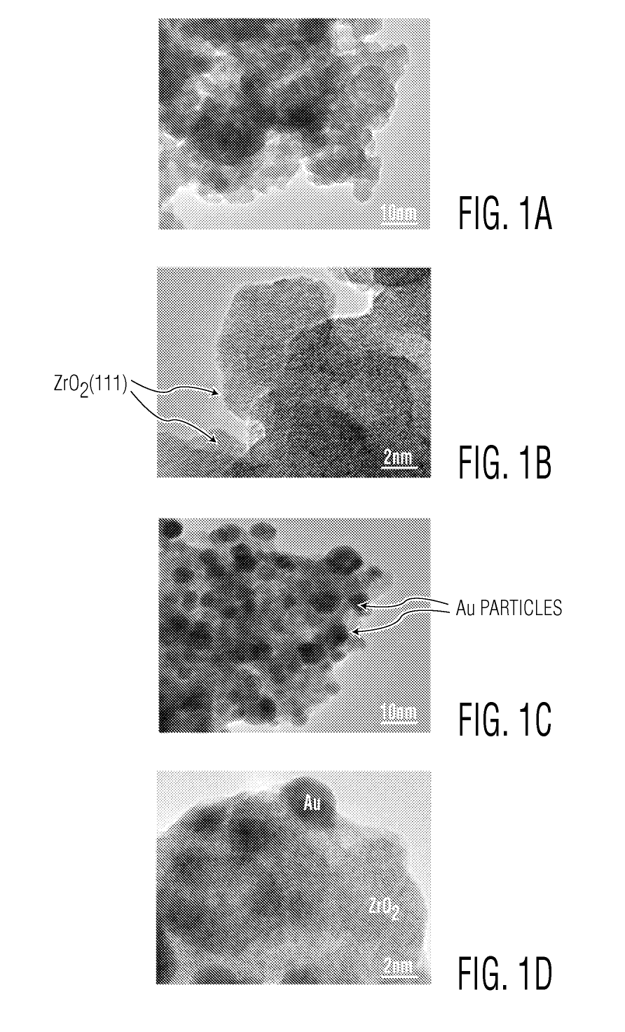

With reference to FIGS. 1A, 1B, 1C, and 1D, samples of zirconia were calcined at about 85° C. (ZrO₂-85) with some loaded with gold nanoparticles utilizing the method described above. The samples exhibited an aggregate particle size in the range of from about 10 to 100 microns. The samples were sonicated in 1 mL of methanol for about 10 minutes and transferred to carbon grids via a micro-liter pipette. A high resolution transmission electron microscopy (JEOL2100 operated at 200 KV) was used to observe the morphology of the samples.

Micrographs of FIGS. 1A and 1B show ZrO₂-85 absent gold nanoparticles at low and high magnifications, respectively, and the micrographs of FIGS. 1C and 1D show gold nanoparticle-dispersed ZrO₂-85 at low and high magnifications, respectively. The zirconia support of the micrographs of FIGS. 1A and 1B, respectively, clearly indicates a distribution of irregular shaped crystalline particles containing primarily monoclinic-ZrO₂ surfaces with a mean particle size of 7.0 nm+/−3 nm (1σ). In contrast, the morphology of the gold nanoparticles shows discreet particles with a mean particle size of 4.0 nm+/−1 nm (1σ) that are highly dispersed and intercalated between ZrO₂ clusters.

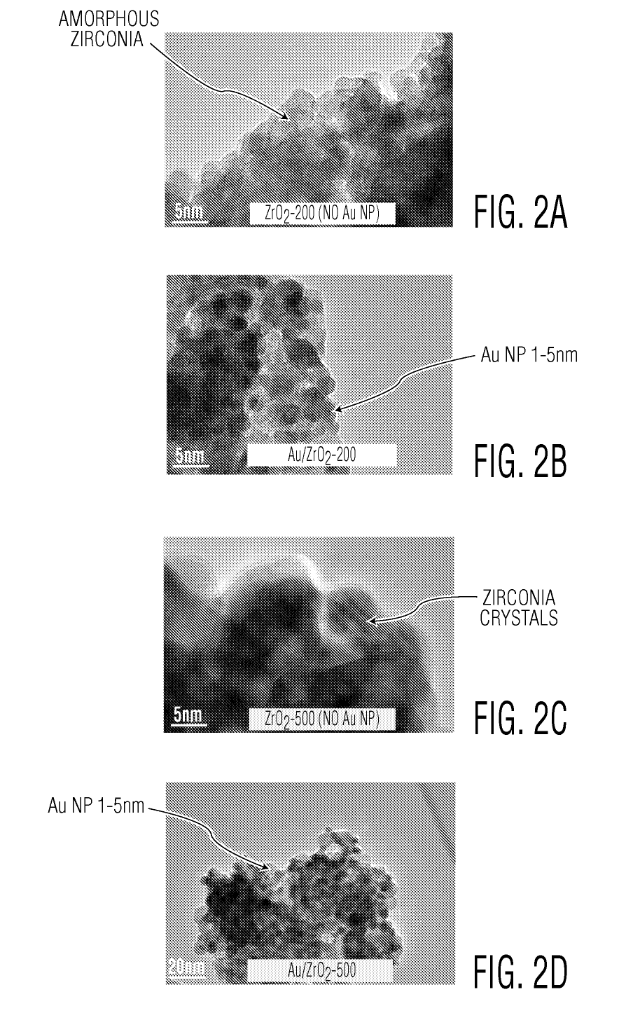

Referring to FIGS. 2A, 2B, 2C and 2D, respectively, samples of zirconia were calcined at either 200° C. (ZrO₂-200) or 500° C. (ZrO₂-500) with select samples loaded with gold nanoparticles utilizing the method described above. The micrographs of FIGS. 2A and 2B show ZrO₂-200 absent gold nanoparticles and ZrO₂-200 loaded with gold nanoparticles, respectively. The sample of ZrO₂-200 shown in the micrographs of FIG. 2A exhibits clusters of ZrO₂ ranging in size of from about 5 nm to 10 nm and composing amorphous-like particles of short range order. The sample of ZrO₂-200 shown in the micrograph of FIG. 2B contained about 2 wt % of gold nanoparticles ranging in size of from about 1 nm to 5 nm, and highly dispersed on the ZrO₂-200 support. As shown in the micrograph of FIG. 2B, the structural characteristics of the ZrO₂-200 support remain unchanged with the addition of the gold nanoparticles.

The sample of ZrO₂-500 as shown in the micrograph of FIG. 2C exhibits a dramatic change in crystal growth with particles ranging in size of from about 15 nm to 30 nm. The sample of ZrO₂-500 shown in the micrograph of FIG. 2D contained about 2 wt % of gold nanoparticles ranging in size of from about 1 nm to 5 nm, and highly dispersed on the ZrO₂-200 support. As further shown in the micrograph of FIG. 2D, the structural characteristics of the ZrO₂-500 support remain unchanged with the addition of the gold nanoparticles.

In another embodiment of the present invention, there is provided a method of decontaminating an air stream suspected of containing carbon monoxide. The method includes the steps of preparing a catalytic sorbent comprising a porous support composed of hydroxylated metal oxide, and a catalytic metal in the form of nanoparticles loaded on the porous support, and b) passing the air stream through the catalytic sorbent.

The catalytic sorbents of the present invention can be implemented or employed in various suitable arrangements of process conditions, depending upon the nature of the air streams to be purified. It will be understood that the present invention is not limited to the detoxification, neutralization or decontamination of carbon monoxide, and may encompass the detoxification, neutralization or decontamination of any toxic industrial chemicals in the air streams through contact with the catalytic metal and hydroxylated metal oxide combination to produce a reaction product that is less toxic and safer than the initial toxic industrial chemical. Mere physical contact of the toxic industrial chemical with the present catalytic sorbent is sufficient to initiate the decontamination process.

The catalytic sorbent of the present invention is useful in greatly reducing or eliminating toxic industrial chemicals from an air stream passing therethrough and releasing less toxic products back into the passing air stream. In a preferred embodiment of the present invention, the catalytic sorbent is used to catalytically convert carbon monoxide into carbon dioxide for release back into the air stream. The conditions required for carrying out the claimed methods can generally be described as ambient environmental conditions. For example, the methods can be used preferably at temperatures ranging from about 25° C. to about 150° C.

While not intending to be bound by theory, it is believed that the highly dispersed hydroxyl (OH) groups contained on the porous support of the present invention, function in place of water molecules to decompose any carbonate formed from the intermediate reaction of carbon monoxide, which stabilizes the catalytic activity of the gold nanoparticles. The increased surface area in the porous support facilitates the accommodation of larger concentrations of the active surface functional groups such as hydroxyls in combination with the dispersed gold nanoparticles. It is further believed that the surface hydroxyl groups participate in a complex series of reactions involving molecular oxygen and water. The hydroxyl groups in combination with the gold nanoparticles promote the initial reaction of carbon monoxide to yield a carbonate compound. The hydroxyl groups facilitate the formation of superoxide (O₂⁻), which reacts and oxidizes the carbonate compound to yield carbon dioxide.

### EXAMPLES

The following examples serve to provide further appreciation of the invention but are not meant in any way to restrict the effective scope of the invention.

### Example 1

### Preparation of a Catalytic Sorbent of the Present Invention

A hydroxylated form of zirconia (designated herein as ZrO₂) commercially prepared and available from Magnesium Elektron Inc. of Flemington, N.J. was obtained. The as-received ZrO₂ samples contained water in amounts of from about 0.24 to 0.28 gram per gram ZrO₂. The ZrO₂ sample (designated herein as ZrO₂-85) was calcined at a temperature of about 85° C. for about six hours. The ZrO₂-85 sample was then loaded with gold nanoparticles via colloidal deposition. The deposition technique used is similar to methods disclosed in Prati et al., Topics in Catalysis, 2009, 52, 288-296, and Comotti et al., Topics in Catalysis, 2007, 44, 275-284, the contents of which are hereby incorporated by reference.

The deposition involved the preparation of reduced gold nanoparticles from a solution of AuCl₃.HCl (7.5 ml, 0.008 M). The solution was diluted to 150 mL with 18 Mohm deionized water. To produce a sample with a particular pH between 3 and 9, the pH of the resulting solution was adjusted using 0.1 M NaOH and HCl. 1 mL of PVA (1 wt % in water) was added to the solution. The resulting solution was stirred at room temperature for about 2 hours. 120 μl 0.5 M NaBH₄ in 2-methoxyethyl ether were added drop-wise resulting in a clear reddish orange solution.

The clear reddish-orange solution containing reduced gold nanoparticles was added drop-wise to 100 ml deionized water containing 0.5 g ZrO₂-85 followed by rapid stirring for about 12 hours at room temperature. The resulting sample solution was filtered, and washed with distilled deionized water. It is noted that for mid- and high-range pH preparations, the filtrate solution vias clear and colorless indicating that nearly all of the gold was deposited on the metal oxide. At low pH, the filtrate solution contained a significant amount of gold based on the appearance of the reddish clear solution. The filtrate solution was dried at 85° C. to yield a sample of Au/ZrO₂-85. The resulting Au/ZrO₂-85 sample contained about 2.0 wt % Au.

### Example 2

### Comparative Samples of Catalytic Sorbents of the Present Invention and Titania-Based Catalysts and their Textural Properties

Samples of catalytic sorbents of the present invention were prepared from a hydroxylated form of zirconia (designated herein as ZrO₂). The hydroxylated form of zirconia was obtained commercially prepared and available from Magnesium Elektron Inc. of Flemington, N.J. The as-received ZrO₂ contained water in amounts of from about 0.24 to 0.28 gram per gram ZrO₂. The samples of ZrO₂ were divided into different groups. One group (designated herein as ZrO₂-85) was calcined in a static oven at a temperature of about 85° C. for about six hours. A second group (designated herein as ZrO₂-200) was calcined in a static oven at a temperature of about 200° C. for about 6 hours. A third group (designated herein as ZrO₂-500) was calcined in a static oven at a temperature of about 500° C. for about six hours.

Three titania substrates or supports, Ti-ana (101), Ti-iso (101) and Ti-nt (001), were selected and prepared for comparison with the zirconia supports. The titania supports were selected based on higher performance results, and representation of various structures and morphologies. Ti-ana, a low porosity anatase, was obtained in the form of a nanopowder (˜25 nm) from Sigma-Aldrich of St. Louis, Mo. Ti-iso was prepared by hydrolysis of titania isopropoxide in a water-alcohol solution at room temperature, filtered, washed and dried at 85° C. Titania isopropoxide was obtained from Sigma-Aldrich. Ti-nt, a hydroxylated titania nanotube powder with aggregates ranging in size of from about 5 μm to 10 μm, was synthesized using the method disclosed in Mogilevsky et al., Chemical Physics Letters, 2008, 460, 517-520, the content of which is hereby incorporated by reference. The titania supports were calcined in a static oven at a temperature of about 85° C. for about six hours.

The ZrO₂ and titania supports were loaded with gold nanoparticles using the method described in Example 2. The clear reddish-orange solutions containing reduced gold nanoparticles were added drop-wise to 100 ml deionized water containing 0.5 g ZrO₂-85, ZrO₂-200, ZrO₂-500, Ti-ana, Ti-iso and Ti-nt, respectively, each followed by rapid stirring for about 12 hours at room temperature. The resulting sample solutions were filtered, washed with distilled deionized water and dried at 85° C. to yield the gold nanoparticle loaded samples. Each sample contained about 2.0 wt % Au.

The textural properties derived from nitrogen isotherms measured for several zirconia and titania samples are listed in Table 1 below.

TABLE 1
Textural properties of zirconia and titania samples

| | BET Surface | Pore | V_{micro} |
|---|---|---|---|
| Sample | Area(m²/g) | Width(nm) | (ml/g) |
| ZrO₂-85 | 532 | 2.1 | 0.180 |
| ZrO₂-200 | 451 | 2.8 | 0.130 |
| ZrO₂-500 | 108 | 2.4 | 0.054 |
| Ti-ana-85 | 206 | 2.5 | 0.077 |
| Ti-nt-85 | 256 | 1.9 | 0.089 |
| Ti-iso-85 | 577 | 1.6 | 0.190 |

The data indicates a dramatic loss in porosity for the ZrO₂ samples with increasing calcination temperature, with BET surface areas decreasing from 532 m²/g to 108 m²/g over a temperature range of 85° C. to 500° C. Similarly, the micropore volume (V_{micro}) decreased from 0.18 ml/g to 0.054 ml/g over the same temperature range. Although not reported, the addition of gold nanoparticles to zirconia and titania resulted in a negligible change in BET surface areas and micropore volumes.

### Example 3

### Catalytic Carbon Monoxide Oxidation Test Apparatus

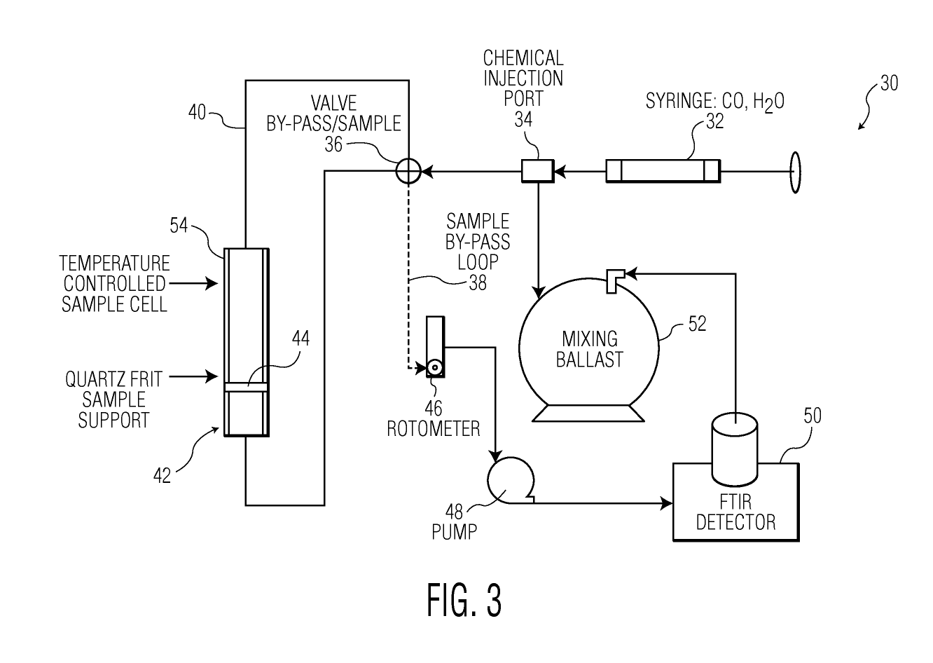

A study was initiated to report the properties and catalytic activities of a hydroxylated polymorphic zirconia comprising a mixture of Zr(OH)₄.nH₂O and crystalline ZrO₂.nH₂O, supporting gold nanoparticles, and various titania supports, using a test apparatus 30 shown in FIG. 3.

As shown in FIG. 3, the test apparatus 30 was used for measuring the activity of catalyst materials by means of exposing a sample catalyst to a known concentration of chemical adsorbate. The test apparatus 30 consists of a closed-circuit construction through which a gas mixture is circulated through a bed of sample catalyst at fixed airflow velocities. The test apparatus includes a syringe 32 containing a chemical adsorbate (i.e., carbon monoxide), a chemical injection port 34 for receiving the chemical adsorbate from the syringe 32, and a stream selection valve 36 for directing the gas mixture through either a sample bypass loop 38 or a sample testing loop 40. The sample testing loop 40 includes a temperature controlled sample cell 42 with a quartz frit sample support 44. The sample bypass loop 38 and the sample testing loop 40 are each connected to a rotometer 46 for controlling flow rate, a pump 48, a fourier transform infrared (FTIR) detector 50, and a mixing ballast 52.

The gas phase concentration of primary adsorbate and reaction product(s) are measured downstream from the sample cell 42 by the FTIR detector 50. The gas mixture is returned to the sample cell repeatedly by the pump 48. During testing, the FTIR detector 50 monitors the concentration of the adsorbate and the reaction products. In the case of carbon monoxide oxidation with catalyst, carbon dioxide is formed and released into the gas phase. The depletion of carbon monoxide and the increase in carbon dioxide formation is monitored concurrently with the FTIR detector 50.

The sample cell 42 comprises a 15 cm long glass tube 54 with a 10 mm inside diameter and 15 mm outside diameter. The sample cell 42 includes a ⅜-inch metal coupling fused to each end of the glass tube 54. The metal couplings are fitted with a swagelok ⅜ inch nut and ferrule for connection to sample lines. A resistive heating wrap (not shown) enveloping the glass sample tube 54 is used to regulate the temperature of the sample cell 42. A thermocouple (not shown) is placed between the heat wrap and the glass tube 54 to monitor the temperature.

The quartz frit sample support 44 is disposed within the glass sample tube 54 for retaining the catalyst sample. The frit sample support 44 is porous to allow the gas mixture to pass through the catalyst sample. The flow is maintained in the downwardly direction to prevent fluidizing of the catalyst sample. The rotometer 46 regulates the gas flow rate through the tube 54. The pump 48 is a bellows pump containing stainless-steel reed valves. The flow rate is typically 250 ml/min during activity measurements, but can be adjusted from zero to about 3000 ml/min.

A stream selection valve 36 is disposed upstream from the sample cell 42 to direct the flow of the gas mixture into the sample cell 42 or to bypass the sample cell 42. The bypass loop 38 allows the gas mixture concentration to be established before exposure to the sample catalyst retained within the sample cell 42.

The gas mixture concentration is based on the mass of chemical injected into the test apparatus 30 and the total volume of the test apparatus 30. The volume of the test apparatus 30 comprises the mixing ballast 52 at 6.0 L and the cell of the FTIR detector 50 at about 2.0 L. The total system volume including tubing, valves and connecting fittings is 8.77 L.

### Example 4

### Catalytic Carbon Monoxide Oxidation Testing and Comparison

The activities of zirconia- and titania-based catalysts of Example 2 were investigated based on the oxidation of carbon monoxide (CO) to carbon dioxide (CO₂) in air under humid and dry conditions, respectively. The activities were ranked based on the calculated % CO₂ yield and rate of CO reaction (or CO₂ formation) expressed as mol-CO/mol-Au-s.

The following test conditions were used for all catalyst samples in the test apparatus 30: sample cell temperature was in the range of from about 25° C. to 125° C., initial carbon monoxide concentration was about 1200 ppm in purified air, sample weight was about 100 mg, CO feed rate initial was about 0.2 μmol/s, flow rate through catalyst bed was about 250 ml/min, relative humidity was about 25% (at 25° C.) or dry air, and space velocity was about 75,000 h⁻¹.

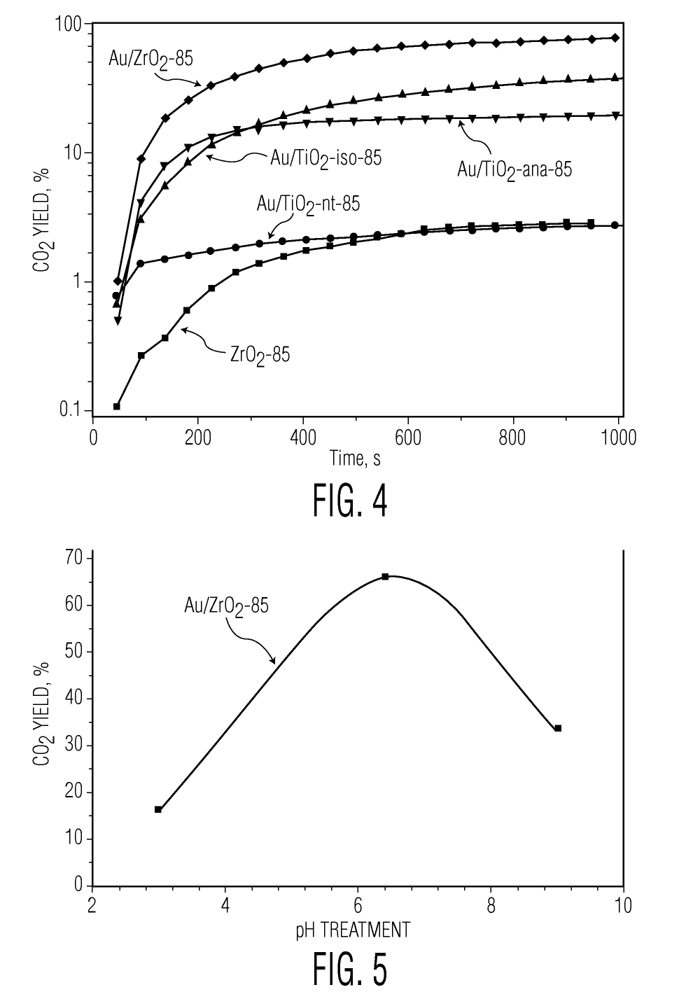

A comparison was made for various Au/ZrO₂ and Au/TiO₂ catalyst samples, each prepared at pH 6.4 and calcined at 85° C. FIG. 4 shows a semilogarithmic plot illustrating low and high concentrations of catalytic activity for carbon monoxide conversion in samples containing ZrO₂-85, Au/ZrO₂-85, Au/Ti-ana-85, Au/Ti-iso-85 and Au/Ti-nt-85. Clearly, the performance for each of the Au/ZrO₂-85 materials exceeds that of the titania supported catalysts (the same size and concentration of gold nanoparticles) by a factor of four or more. Pure zirconia, with no gold nanoparticles attached, shows very weak activity (2% or less conversion), supporting that gold is acting as the catalyst.

A determination of the catalytic activity of Au/ZrO₂ calcined at 85° C. was made based on various acid-base treatments in the range of from about pH 3 to 9. The feed stream of the testing apparatus 30 was set at 1200 ppm CO, 21 vol % O₂, 79 vol % N₂, and 25% relative humidity. FIG. 5 shows the measured catalytic activity in terms of percent CO₂ yield after 500 seconds of exposure to the CO/water mixture. The results of the pH evaluation, clearly indicate that maximum conversion (reported as % CO₂ yield) occurred at a pH of about 6.4 (66.1% carbon dioxide yield) followed by 33% and 16% carbon dioxide yield at pH 9 and 3, respectively. The effect of pH treatment and catalyst activity is likely related to the ratio of cations and anions in solution containing gold nanoparticles and the surface of the metal oxide. Under neutral conditions (point of zero charge, pzc) the surface environment is ionic neutral. The pzc for the zirconia and titania supports occur near pH 6.4.

To understand the effect of calcination temperature on carbon monoxide oxidation activity, Au/ZrO₂ catalysts were evaluated over a temperature range of 85° C. to 500° C. Each of the samples was prepared at pH 6.4. As shown in Table 2, calcination temperature dramatically changes catalyst activity with the highest performance occurring in the range of 85° C. (66.1% carbon dioxide yield) to 200° C. (14.8% carbon dioxide yield). At the highest temperature, 500° C., catalyst activity decreased markedly to less than 5.4% carbon dioxide yield. The observed trend in catalyst activity was anticipated due to a similar decrease in porosity with increasing calcination temperature. In fact, the change in activity with calcination temperature is roughly proportional to the change in BET surface area. In addition, it has been reported that significant loss of surface hydroxyl groups occurs above 200° C., thus further reducing the number of active sites available for reaction.

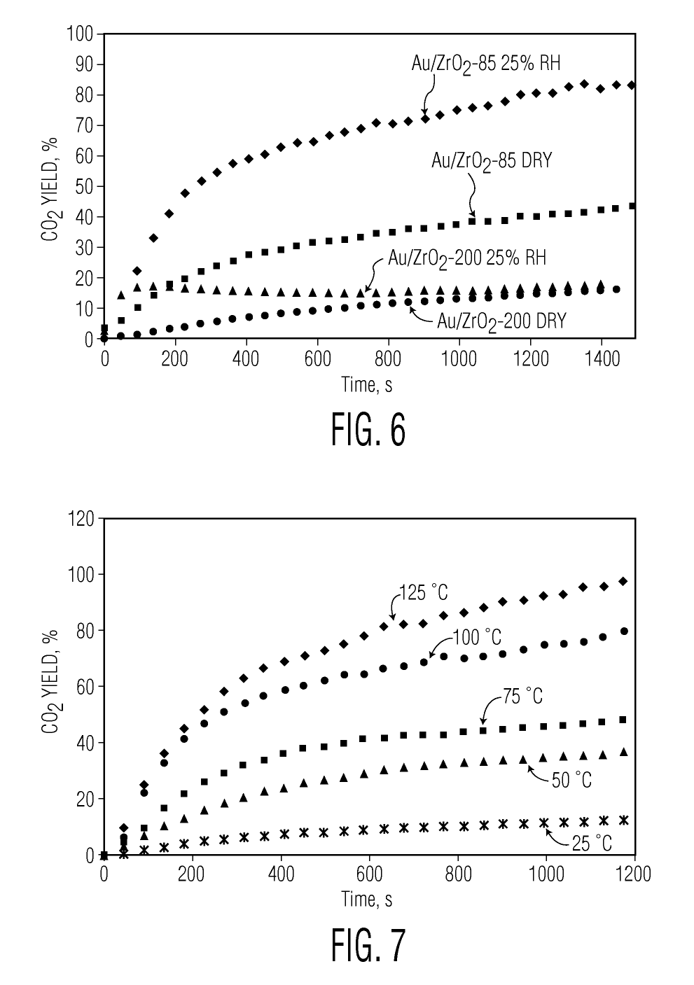

Considering the trends discussed above, a comparison was made for various Au/ZrO₂ catalyst samples prepared at pH 6.4 and calcined at 85° C. and 200° C., respectively. The feed stream of the testing apparatus 30 was set at 1200 ppm CO, 21 vol % O₂, 79 vol % N₂, and 25% RH or dry. FIG. 6 shows plotted data illustrating low and high concentrations of catalytic activity for carbon monoxide conversion in samples containing Au/ZrO₂-85, and Au/ZrO₂-200 tested at 25% RH (relative humidity) and dry conditions. When tested at 25% RH conditions the performance of the Au/ZrO₂-85 material exceeds that of the Au/ZrO₂-200 catalyst samples (the same size and concentration of gold nanoparticles) by a factor of four or more. When tested under dry conditions the overall performance is approximately 50% lower than at 25% RH conditions. Similarly the Au/ZrO₂-85 catalyst performed better than the Au/ZrO₂-200 catalyst under dry conditions.

A summary of carbon monoxide conversion rates and percent carbon dioxide yield referenced at 500 seconds (time of exposure to CO) is provided in Table 2 below.

TABLE 2
CO conversion rate and percent CO₂ yield

| | CO conversion rate | % CO₂ yield at |
|---|---|---|
| Catalyst ID | mol-CO/mol-Au-s | 500 s |
| ZrO₂-85 | 0.0018 | 2.0 |
| Au/ZrO₂-85 (pH 6.4) | 0.0454 +/− 0.012 (n = 5) | 66.1 +/− 16.9 (n = 5) |
| | 0.0240 +/− 0.0052 (dry) | 33.8 +/− 7.3 (dry) |
| Au/ZrO₂-200 (pH 6.4) | 0.0072 | 14.8 |
| | 0.005 (dry) | 7.2 (dry) |
| Au/ZrO₂-500 (pH 6.4) | 0.0038 | 5.4 |
| Au/ZrO₂-85 (pH 9.0) | 0.0291 | 33.0 |
| Au/ZrO₂-85 (pH 3.0) | 0.0143 | 16.2 |

For the Au/ZrO₂ samples calcined at 85° C., 200° C. and 500° C. (pH 6.4), a significant increase in carbon monoxide conversion rate is observed from 0.0038 to 0.0454 mol-CO/mol-Au-s, respectively, while the percent carbon dioxide yield decreased from a maximum of 66.1% and 14.8% (for the 85° C. and 200° C. samples) to 5.4% for the Au/ZrO₂-500 sample.

FIG. 7 provides plotted data of catalytic activities showing a data comparison of carbon dioxide as a percent yield of samples containing gold nanoparticles dispersed on hydroxylated zirconia at various temperatures. The feed stream of the testing apparatus 30 was set at 1200 ppm CO, 21 vol % O₂, 79 vol % N₂, and 25% relative humidity. The temperature trend shows that the catalyst activity increases with increasing temperature of the feed stream over a range of from 25° C. to 125° C. At 1000 seconds (time of exposure to CO), the percent CO₂ yield is about 15% and increases to about 35% when the temperature is increased to 50° C. At 75° C., the percent CO₂ conversion yield is about 42%, and with further increase in temperature to 100° C. and 125° C., the CO₂ yield increases to about 75 and 90%, respectively.

Unlike previously reported zirconia materials, where loss of surface hydroxyl groups and reduced porosity resulted from high temperature calcinations, the present hydroxylated form of zirconia shows significant improvement in carbon monoxide oxidation activity. A key factor for this form of zirconia is the ability to adsorb and dissociate water rapidly, thus sustaining the oxidation process. The interaction of water with metal oxide surfaces characterized by hydrogen and oxygen exchange is a critical factor in applications requiring highly efficient catalytic materials. Furthermore, the porosity of the catalyst support plays an important role by providing a high concentration of active sites while enabling higher turnover rates and conversions.

For the most stable forms of zirconia, water is entirely dissociated, which is likely influenced by interaction through hydrogen bonding between hydroxyl groups adsorbed on neighboring cationic sites. In contrast, titania's interaction with water involves whole molecules participating in adsorption and dissociation which is surface coverage dependent. The specific interactions involving water with polymorphic structures is likely responsible for the differences in catalytic performance that we observed in this evaluation.

In summary, this study reports the exceptional carbon monoxide oxidation activity of a novel catalyst: micro/meso-porous hydroxylated zirconia of polymorphic composition supporting gold nanoparticles. Hydroxylated zirconia provides a better support for gold catalyst than titania, which was considered to be the most efficient catalytic support until now. This study also demonstrated the effect of calcination temperature on structural transformation of amorphous zirconia to the polymorphic crystalline forms with reduction in porosity, as well as the reduction in carbon monoxide activity with loss of surface hydroxyl groups. With further work in elucidating the relationship of surface hydroxyl groups and microporosity of metal oxides, improved strategies for tailoring properties of functional catalysts can be developed.

The forgoing discussion discloses and describes merely exemplary embodiments of the present invention. One skilled in the art will readily recognize from such discussion, and from the accompanying claims, that various changes, modifications, and variations can be made therein without departing from the spirit and scope of the invention as defined in the following claims.

What is claimed is:

1. A catalytic sorbent, comprising:
a porous support composed of hydroxylated metal oxide; and
a catalytic metal in the form of nanoparticles loaded on the porous support.

2. The catalytic sorbent of claim 1, wherein the porous support further comprises a pore size of less than 50 nm.

3. The catalytic sorbent of claim 2, wherein the pore size is less than 2 nm.

4. The catalytic sorbent of claim 1, wherein the porous support further comprises a crystal size of less than 10 nm.

5. The catalytic sorbent of claim 4, wherein said crystal size is less than 2 nm.

6. The catalytic sorbent of claim 1, wherein the catalytic metal is selected from the group consisting of gold, cerium, rhodium, platinum, copper, zinc, and combinations thereof.

7. The catalytic sorbent of claim 1, wherein the catalytic metal is gold.

8. The catalytic sorbent of claim 1, wherein the hydroxylated metal oxide is selected from the group consisting of: zirconium (IV) hydroxide (Zr(OH)₄); zirconia (ZrO₂.nH₂O); zirconium (IV) hydroxide (Zr(OH)₄) zirconia (ZrO₂.nH₂O); hydroxylated polymorphic zirconia; zirconium oxyhydroxides; and combinations thereof.

9. The catalytic sorbent of claim 1, wherein the porous support is hydroxylated zirconia.

10. The catalytic sorbent of claim 1, wherein the hydroxylated metal oxide comprises a concentration of hydroxyl groups in the range of from about 0.1 to 0.6 surface fraction based on the total available surface of the catalytic sorbent.

11. The catalytic sorbent of claim 10, wherein the hydroxylated metal oxide comprises a concentration of hydroxyl groups in the range of from about 0.3 to 0.5 surface fraction based on the total available surface of the catalytic sorbent.

12. The catalytic sorbent of claim 1, wherein the porous support comprises a surface area of at least 100 m²g⁻¹.

13. The catalytic sorbent of claim 12, wherein the porous support comprises a surface area of from about 100 m²g⁻¹ to 1000 m²g⁻¹.

14. The catalytic sorbent of claim 1, wherein the porous support comprises a pH value of from about 3 to 9.

15. The catalytic sorbent of claim 14, wherein the pH value is 6.

16. The catalytic sorbent of claim 1, wherein the nanoparticles comprise a mean average particle size of less than 10 nm.

17. The catalytic sorbent of claim 1, wherein the nanoparticles comprise a mean average particle size in the range of from about 0.1 nm to 5 nm.

18. The catalytic sorbent of claim 1, wherein the catalytic metal is present in an amount sufficient to catalytically react with carbon monoxide to yield a less toxic product.

19. The catalytic sorbent of claim 18, wherein the amount of the catalytic metal is at least 0.01% by weight based on the total weight of the catalytic sorbent.

20. The catalytic sorbent of claim 1, wherein the amount of the catalytic metal is in the range of from about 0.1% by weight to 20% by weight based on the total weight of the catalytic sorbent.

21. The catalytic sorbent of claim 1, wherein the porous support is amorphous.

22. A catalytic sorbent comprising:
a porous support composed of hydroxylated zirconia; and
gold nanoparticles loaded on the porous support.

23. A method of decontaminating an air stream suspected of containing carbon monoxide, said method comprising:
a) preparing a catalytic sorbent comprising:
a porous support composed of hydroxylated metal oxide; and
a catalytic metal in the form of nanoparticles loaded on the porous support; and
b) passing the air stream through the catalytic sorbent.
